(19) United States
(12) Patent Application Publication
(10) Pub. No.: US 2012/0153049 A1
(43) Pub. Date: Jun. 21, 2012

(54) CLEANING AND DETECTION SYSTEM FOR AUTOMATIC PAINT SPRAYER

(75) Inventors: Rihui Zhu, Guangdong (CN); Songhu Li, Guangdong (CN)

(73) Assignee: GUANGQI HONDA AUTOMOBILE CO., LTD., Guangzhou, Guangdong (CN)

(21) Appl. No.: 13/144,081

(22) PCT Filed: Feb. 25, 2011
(86) PCT No.: PCT/CN2011/071332

§ 371 Date: Jul. 11, 2011

(30) Foreign Application Priority Data
Dec. 17, 2010 (CN) 201010593944.6

(51) Int. Cl. B05B 9/00

(52) U.S. Cl. 239/330

(57) ABSTRACT

A cleaning and detection system for automatic paint sprayer is provided, comprising a compressed air supplying device, a solvent supplying device, a diaphragm pump connected to the solvent supplying device for pumping the solvent from the solvent supplying device at a predetermined pressure, and a plurality of conduits for enabling the solvent and compressed air to access to the solvent valve, triple valve and spray gun of the automatic paint sprayer for cleaning thereof. In the meantime, the solvent discharged from the sprayer is returned to the solvent supplying device for recycling. The present system takes use of the working principle of the sprayer and cleans the valves and spray gun with a mixture of compressed air and solvent, achieving a perfect cleaning effect. The system can also be used to detect the whether the valve core is damaged or displaced by observing the movement and possible leakage of the valve core.

### CROSS-REFERENCE TO RELATED APPLICATIONS

The present application claims priority from China Patent Application No. 201010593944.6 filed on Dec. 17, 2010 in the name of GuangQi Honda Automobile Co., Ltd. The entire disclosure of the application is incorporated herein by reference.

### FIELD OF THE INVENTION

The present invention relates to a cleaning and detection system for automatic paint sprayer, particularly to a cleaning and detection system for triple valve, solvent valve and spray gun of the paint sprayer.

### BACKGROUND OF THE INVENTION

Automatic paint sprayer is one of the most important apparatuses used in automobile painting workshop. The performance of the paint sprayer directly correlates with the painting quality. However, the triple valve, solvent valve and spray gun of the paint sprayer are easier subject to failure or obstruction. Conventional technologies directly employ solvent to flush the valve and spray gun. However, these methods do not have desirable effect and it is difficult for these methods to wash off impurities such as paint sediment. In this case, when the paint sprayer is put into use again, deficiencies such as paint sediment, foreign objects, particles, solvent mark, and color mixing will adversely and significantly affect the painting quality. Removing and replacing the paint sprayer is very time-consuming and labor-intensive, causing a significant influence on productivity utilization.

In another aspect, conventional technologies cannot detect whether a repaired valve or spray gun will experience leaking or poor switching. Thus the condition of the sprayer after repairing cannot be determined prior to a trial run. Potential quality hazards may be still present even after the trial run, resulting in secondary failures. In practice, secondary failures due to valve and spray gun deficiencies account for more than 40% of total failures. The productivity utilization and production quality is thus greatly influenced. Potential safety hazards are also present.

Therefore, there is a need for a system capable of cleaning and detecting the triple valve, solvent valve and spray gun of a paint sprayer.

### SUMMARY OF THE INVENTION

An object of the invention is to provide a system to clean and detect triple valve, solvent valve and spray gun of a paint sprayer. The system of the present invention is capable of both effectively cleaning and detecting, with an aim to reduce, or even obviate, the possibility of secondary failure.

In order to achieve the above object, a cleaning and detection system for automatic paint sprayer is provided, comprising

a compressed air supplying device;

a solvent supplying device;

a diaphragm pump, connected to the solvent supplying device for pumping the solvent from the solvent supplying device at a predetermined pressure;

a first conduit, connected to an output of the compressed air supplying device at a first end of the first conduit;

a multiconnector, connected to the first conduit at a second end of the first conduit, the multiconnector having a plurality of connectors;

a third conduit, connected to a first connector of the multiconnector at a first end of the third conduit;

a second conduit, provided with a ball valve, a check valve and a pressure meter for measuring pressure inside the second conduit, the second conduit being connected to a second end of the third conduit and an inlet of a solvent valve to be cleaned and detected at respective ends of the second conduit for providing to the solvent valve compressed air at a predetermined pressure, the check valve being located inside the second conduit between the ball valve and the inlet of the solvent valve;

a fourth conduit, connected to the diaphragm pump and another inlet of the solvent valve at respective ends of the fourth conduit for providing solvent to the solvent valve, and another check valve being provided in the fourth conduit;

a fifth conduit and a sixth conduit, connected to a second and third connectors of the multiconnector respectively at first ends of the fifth and sixth conduits, and to air control orifices of the solvent valves at second ends of the fifth and sixth conduits for air-controlling open and close of a valve core of the solvent valve;

a seventh conduit, a eighth conduit and a ninth conduit, connected to a fourth, fifth and sixth connectors of the multiconnector respectively at first ends of the seventh, eighth and ninth conduits, and to air control orifices of a triple valve to be cleaned and detected at second ends of the seventh, eighth and ninth conduits for air-controlling open and close of a valve core of the triple valve;

a tenth conduit, connected to an outlet of the solvent valve at a first end of the tenth conduit and to the triple valve at a second end of the tenth conduit for providing to the triple valve a mixture of compressed air and solvent;

a eleventh conduit, connected to the triple valve for outputting the solvent from the triple valve;

a twelfth conduit, connected to the outlet of the solvent valve or an outlet of the triple valve at a first end of the twelfth conduit, and to an inlet of a spray gun at a second end of the twelfth conduit for enabling the mixture of compressed air and solvent to access to the spray gun;

a thirteenth conduit, connected to an outlet of the spray gun for discharging the solvent from the spray gun.

Preferably, the tenth conduit is connected to a mixture outlet of the triple valve, and the eleventh conduit comprising three branches which are connected to a solvent inlet, a paint inlet and waste return orifice of the triple valve respectively.

Preferably, the tenth conduit has two branches connected to the solvent inlet and paint inlet of the triple valve respectively. The eleventh conduit is connected to the mixture outlet of the triple valve. In addition, the twelfth conduit is connected to the waste return orifice of the triple valve and the solvent supplying device at respective ends of the twelfth conduit.

Preferably, a manual pneumatic switch is provided in the first conduit.

Preferably, the pressure of the compressed air provided to the solvent valve is set to be 0.35 MPa or more. The pressure of the solvent provided to the solvent valve is set to be 0.35 MPa or more.

Preferably, the thirteenth conduit is connected to the solvent supplying device at another end. A filter is provided to the solvent supplying device for filtering the solvent from the thirteenth conduit for recycling.

The present invention follows the working principle of a paint sprayer and supplies the mixture of compressed air and solvent to the solvent valve, triple valve and spray gun to flush the latter. In the meantime, by observing the movement of valve core, the operator can determine whether the valve core is damaged or displaced. If the movement of the valve core is slowed or blocked, repair or other maintenance is required. Moreover, the quality of repairing can be evaluated by determining whether the valves and spray gun are experiencing leakage. In this way, the quality of the solvent valve, triple valve and spray gun can be evaluated off-line, without the need of trial run. Secondary failure due to deficient valve or spray gun employed in the sprayer can be reduced to a minimum extent.

### BRIEF DESCRIPTION OF DRAWINGS

FIG. 1 is a schematic view of a cleaning and detection system for triple valve, solvent valve and spray gun of an automatic paint sprayer according to a preferable example of the present invention.

### DETAILED DESCRIPTION OF THE INVENTION

The present invention will be described in detail with reference to the accompanied drawings.

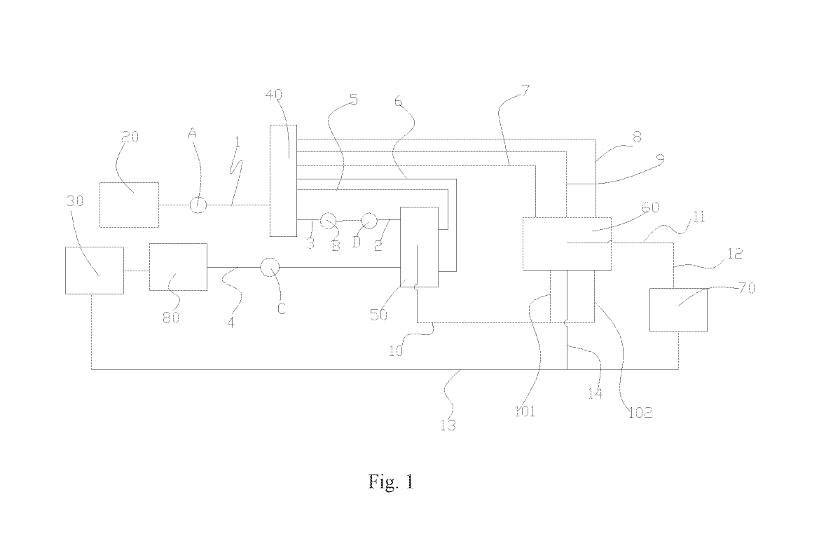

Referring to FIG. 1, the cleaning and detection system in this example comprises:

a compressed air supplying device 20, which can be any suitable compressed air supplying device conventionally used in the art;

a solvent supplying device 30, which is a solvent tank for holding solvent in this example, a filter such as a mesh being provided in the solvent tank to filter the stream discharge from the sprayer, the filter being preferably arranged and constructed to filter out impurities and residues, and the solvent being conventional solvents used in painting techniques, such as color replacement solvents;

a diaphragm pump 80 which is connected to the solvent supplying device 30 for pumping the solvent from the solvent supplying device 30 at a predetermined pressure, the diaphragm pump being replaceable by other pump, preferably made of materials not prone to generate static charge, such as plastics, in order to reduce production risk;

a first conduit 1, which is at one end connected to an air output of the compressed air supplying device 20, the first conduit 1 being preferably provided with a manual air control switch A by which air delivery can be controlled, and in a less preferable example, the air control switch A being omitted with the air delivery control achieved by switching the air supplying device 20 or by the engagement/disengagement of the first conduit 1;

a multiconnector 40, which is connected to the other end of the first conduit 1, the multiconnector 40 having a plurality of connectors with each connector connected to a corresponding conduit or blocked if not connected, and the multiconnector 40 having 7 connectors in this example;

a third conduit 3, which is at one end connected to a first connector of the multiconnector 40;

a second conduit 2, which is provided with a ball valve B, a check valve D and a pressure meter for measuring the pressure inside the conduit, in practice, the pressure being set as necessary by adjusting the ball valve B according to the readings on the pressure meter, the second conduit 2 being connected at one end to the other end of the third conduit 3 and at the other end to a first inlet of a solvent valve 50 for supplying compressed air at a predetermined pressure to the solvent valve, the check valve D being located in the conduit between the ball valve B and the inlet of the valve for preventing reflux of the solvent into the conduit;

a fourth conduit 4, which is connected at one end to the diaphragm pump 80 and at the other end to a second inlet of the solvent valve 50 for providing solvent to the solvent valve, a check valve C being provided in the fourth conduit 4 for preventing reflux of the solvent;

a fifth conduit and a sixth conduit 5, 6, which are connected to respective connectors of the multiconnector 40 at one ends, and at the other ends to air control orifices of the solvent valve 50 for air-controlling the open and close of the valve core of the solvent valve 50;

a seventh conduit, eighth conduit and ninth conduit 7, 8 and 9, which are connected to respective connectors of the multiconnector 40 at one ends, and at the other ends to air control orifices of a triple valve 60 to be cleaned for air-controlling the open and close of the valve core of the triple valve 60;

a tenth conduit 10, which is connected at one end to an outlet of the solvent valve 50 and at the other end to the triple valve 60 for supplying a mixture of compressed air and solvent to the triple valve 60;

a eleventh conduit 11, which is connected to the triple valve 60 for discharging the mixture of compressed air and solvent from the triple valve 60;

a twelfth conduit 12, which is connected at one end to an outlet of the triple valve 60, i.e., the eleventh conduit 11 in this example, and at the other end to an inlet of a spray gun 70, for enabling the mixture of compressed air and solvent to access to the spray gun 70, then clean the spiral pipe and trigger valve and finally discharge from an outlet of the spray gun; and

a thirteenth conduit 13, which is connected at one end to the outlet of the spray gun and at the other end to the solvent supplying device 30 for recycling. The thirteenth conduit 13 may be omitted if recycling is not desirable.

As an alternative example, the tenth conduit 10 comprises two branches which are connected to the solvent inlet and paint inlet of the triple valve 60 respectively, which are located at both sides of the bottom of the triple valve. The mixture of compressed air and solvent is rushed into the triple valve. Correspondingly, the eleventh conduit 11 is connected to a paint-solvent mixture inlet of the triple valve 60 which is located at the middle of the valve through which the mixture of compressed air and solvent is discharged from the triple valve. In this example, a fourteenth conduit 14 is connected to a waste orifice of the triple valve 60 which is located in the middle of the bottom of valve through which the mixture of compressed air and solvent can also be discharged. The fourteenth conduit 14 can also be connected directly to the solvent supplying device or the eleventh conduit.

In another example of the present invention, the conduit arrangement can be changed. Specifically, the tenth conduit 10 is connected to the paint-solvent mixture inlet of the triple valve 60, and the eleventh conduit 11 comprises three branches which are connected respectively to three orifices (solvent inlet orifice, paint inlet orifice and waste orifice) at the bottom of the triple valve through which the mixture of compressed air and solvent is discharged. Of course, the waste orifice can be connected separately with a conduit to discharge waste.

In a preferable example, there is provided for the spray gun a mounting base which matches well with the spray gun for vertically placement of the spray gun to facilitate cleaning

It can be seen that, in this example, the triple valve and the spray gun is connected in series in the flowing direction of the mixture of compressed air and solvent. Alternatively, the triple valve and the spray gun are connected in parallel, i.e., the spray gun is directly connected to the solvent supplying device by conduits. In the present invention, the solvent valve serves as a mixing component for mixing the solvent and compressed air so as to clean the triple valve and the spray gun. In the meantime, the solvent valve per se is also cleaned.

Based on experiments, the pressure of the compressed air to be input into the solvent valve is set to be 0.35 MPa or more. The pressure can be obtained by adjusting the ball valve B and read from the pressure meter. The pressure of the solvent to be input into the solvent valve is set to be 0.35 MPa or more which is an ordinary output operating pressure of the diaphragm pump. In practice, the pressure of the mixture of compressed air and solvent can reach as high as 0.5 MPa or more, under which it is demonstrated that the cleaning effect is more desirable. Of course, if energy consumption is not a consideration, the pressure of the compressed air can be larger, causing the pressure of the mixture of compressed air and solvent to be larger, resulting in more cleaning power. However, a pressure of 0.5 MPa is preferable.

The present system can also be used to detect the performance of valve cores. When only compressed air is delivered (i.e., the solvent supplying device is switched off), the valve cores will lift and fall by accessing to and cutting off the resource of compressed air (such as by switching on and off the manual air control switch or the compressed air supplying device, or engagement and disengagement of the first conduit). The movement of the valve core can be used to evaluate the performance of the valve. If the movement is slow or blocked, it is considered that the valve is not cleaned completely or the valve core is damaged or displaced. In this case, the valve cannot be put into use and should be removed for further inspection, in order to determine whether it can be repaired or should be disposed.

In addition, the present system can also be used to determine whether the valve and the spray gun are experiencing leakage. When only the solvent is delivered (the valve cores will not be opened), the performance of the valve and valve core (leakage and damage) can be determined by detecting whether there is a leakage at the output conduit of the valve, and the performance of the spray gun (leakage) can be determined by switching off the trigger valve of the spray gun and detecting whether there is a leakage at the nozzle of the spray gun. If leakage is detected, the valves and spray gun used in the system should be removed for further inspection, in order to determine whether they can be repaired or should be disposed.

The above description is made with reference to preferable examples of the present invention and should not be a limiting of the invention. Any equivalent changes or modifications made based on the present invention should be included in the scope of the present invention.

What is claimed is:

1. A cleaning and detection system for automatic paint sprayer, comprising
a compressed air supplying device;
a solvent supplying device;
a diaphragm pump, connected to the solvent supplying device for pumping the solvent from the solvent supplying device at a predetermined pressure;
a first conduit, connected to an output of the compressed air supplying device at a first end of the first conduit;
a multiconnector, connected to the first conduit at a second end of the first conduit, and the multiconnector having a plurality of connectors;
a third conduit, connected to a first connector of the multiconnector at a first end of the third conduit;
a second conduit, provided with a ball valve, a check valve and a pressure meter for measuring pressure inside the second conduit, the second conduit being connected to a second end of the third conduit and an inlet of a solvent valve to be cleaned and detected at respective ends of the second conduit for providing to the solvent valve compressed air at a predetermined pressure, the check valve being located inside the second conduit between the ball valve and the inlet of the solvent valve;
a fourth conduit, connected to the diaphragm pump and another inlet of the solvent valve at respective ends of the fourth conduit for providing solvent to the solvent valve, and another check valve being provided in the fourth conduit;
a fifth conduit and a sixth conduit, connected to a second and third connectors of the multiconnector respectively at first ends of the fifth and sixth conduits, and to air control orifices of the solvent valves at second ends of the fifth and sixth conduits for air-controlling open and close of a valve core of the solvent valve;
a seventh conduit, an eighth conduit and a ninth conduit, connected to a fourth, fifth and sixth connectors of the multiconnector respectively at first ends of the seventh, eighth and ninth conduits, and to air control orifices of a triple valve to be cleaned and detected at second ends of the seventh, eighth and ninth conduits for air-controlling open and close of a valve core of the triple valve;
a tenth conduit, connected to an outlet of the solvent valve at a first end of the tenth conduit and to the triple valve at a second end of the tenth conduit for providing to the triple valve a mixture of compressed air and solvent;
an eleventh conduit, connected to the triple valve for outputting the solvent from the triple valve;
a twelfth conduit, connected to the outlet of the solvent valve or an outlet of the triple valve at a first end of the twelfth conduit, and to an inlet of a spray gun at a second end of the twelfth conduit for enabling the mixture of compressed air and solvent to access to the spray gun; and
a thirteenth conduit, connected to an outlet of the spray gun for discharging the solvent from the spray gun.

2. The cleaning and detection system for automatic paint sprayer of claim 1, wherein the tenth conduit is connected to a mixture outlet of the triple valve, and the eleventh conduit comprises three branches which are connected to a solvent inlet, a paint inlet and waste return orifice of the triple valve respectively.

3. The cleaning and detection system for automatic paint sprayer of claim 1, wherein the tenth conduit has two branches connected to the solvent inlet and paint inlet of the triple valve respectively; the eleventh conduit is connected to the mixture outlet of the triple valve; and, the twelfth conduit is connected to the waste return orifice of the triple valve and the solvent supplying device at respective ends of the twelfth conduit.

4. The cleaning and detection system for automatic paint sprayer of claim 1, wherein a manual pneumatic switch is provided in the first conduit.

5. The cleaning and detection system for automatic paint sprayer of claim 1, wherein the pressure of the compressed air provided to the solvent valve is set to be 0.35 MPa or more; and the pressure of the solvent provided to the solvent valve is set to be 0.35 MPa or more.

6. The cleaning and detection system for automatic paint sprayer of claim 1, wherein the thirteenth conduit is connected to the solvent supplying device at another end, and a filter is provided to the solvent supplying device for filtering the solvent from the thirteenth conduit for recycling.
